(19) United States
(12) Patent Application Publication
(10) Pub. No.: US 2009/0029212 A1
(43) Pub. Date: Jan. 29, 2009

(54) FUEL CELL SYSTEM AND ELECTRONIC DEVICE

(75) Inventors: Kengo Makita, Kanagawa (JP); Shinichi Uesaka, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/175,256

(22) Filed: Jul. 17, 2008

(30) Foreign Application Priority Data
Jul. 26, 2007 (JP) 2007-194514

(51) Int. Cl. H01M 8/04

(52) U.S. Cl. 429/23

(57) ABSTRACT

A fuel cell system capable of suppressing influence of fuel crossover and achieving long-time power generation and an electronic device using it are provided. The fuel cell system includes a power generation section having an electrolytic solution between a fuel electrode and an oxygen electrode, a fuel supply section supplying a fuel to the fuel electrode, and a control section making the fuel supply section stop supplying the fuel to the fuel electrode and thereby performing electrolytic solution cleaning to remove a fuel contained in the electrolytic solution.

### CROSS REFERENCES TO RELATED APPLICATIONS

The present application claims priority to Japanese Patent Application JP 2007-194514 filed in the Japanese Patent Office on Jul. 26, 2007, the entire contents of which being incorporated herein by reference.

### BACKGROUND

The present application relates to a fuel cell system including a Direct Methanol Fuel Cell (DMFC) in which methanol is directly supplied to a fuel electrode to initiate reaction or the like, and an electronic device using it.

Indicators exhibiting characteristics of a battery include an energy density and an output density. The energy density is an energy cumulative amount per unit weight of the battery. The output density is an output amount per unit weight of the battery. A lithium ion secondary has two characteristics of the relatively high energy density and the significantly high output density. In addition, the lithium ion secondary battery is highly-quality finished. Thus, the lithium ion secondary battery is widely adopted as a power source for mobile devices. However, in recent years, there is a tendency that the power consumption of the mobile devices is increased as the mobile devices become sophisticated. Accordingly, it is demanded that the energy density and the output density of the lithium ion secondary battery are further improved.

Solutions thereof include changing the electrode material composing the cathode and the anode, improving the coating method of the electrode material, improving the method of enclosing the electrode material and the like. Researches on improving the energy density of the lithium ion secondary battery have been made, but it is still a far-out technique to achieve the practical use. In addition, unless the component material used for the current lithium ion secondary battery is changed, it is hard to expect substantial improvement of the energy density.

Therefore, it is an urgent need to develop a battery having a higher energy density instead of the lithium ion secondary battery. A fuel cell is one of the strong candidates.

The fuel cell has a structure in which an electrolyte is arranged between an anode (fuel electrode) and a cathode (oxygen electrode). A fuel is supplied to the fuel electrode, and air or oxygen is supplied to the oxygen electrode. In the result, redox reaction in which the fuel is oxidized by oxygen in the fuel electrode and the oxygen electrode is initiated, and part of chemical energy of the fuel is converted to electric energy and extracted.

Various types of fuel cells have been already proposed and experimentally produced, and part thereof is practically used. These fuel cells are categorized into an Alkaline Fuel Cell (AFC), a Phosphoric Acid Fuel Cell (PAFC), a Molten Carbonate Fuel Cell (MCFC), a Solid Electrolyte Fuel Cell (SOFC), a Polymer Electrolyte Fuel Cell (PEFC) and the like according to the electrolyte used. Of the foregoing fuel cells, the PEFC is operatable at lower temperature such as about from 30 deg C. to 130 deg C., compared to the other types of fuel cells.

As a fuel of the fuel cell, various flammable substances such as hydrogen and methanol are used. However, a gas fuel such as hydrogen needs a storage cylinder or the like, and thus the gas fuel is not suitable for realizing a small-sized fuel cell. Meanwhile, a liquid fuel such as methanol is advantageous with regard to the characteristics that the liquid fuel is able to be easily stored. Specially, the DMFC has an advantage that the DMFC does not need a reformer to extract hydrogen from the fuel, and accordingly the structure is simplified and a small-sized fuel cell is thereby easily realized.

In the DMFC, in general, fuel methanol is supplied as a low-concentrated or a high-concentrated aqueous solution, or as pure methanol gas state to a fuel electrode. The supplied methanol is oxidized into carbon dioxide in a catalyst layer of the fuel electrode. Protons generated then are transferred to an oxygen electrode through an electrolyte membrane that separates the fuel electrode from the oxygen electrode, and are reacted with oxygen in the oxygen electrode to generate water. The reactions initiated in the fuel electrode, the oxygen electrode, and the entire DMFC are expressed as Chemical formula 1.

Fuel electrode: CH₃OH+H₂O→CO₂+6e⁻+6H⁺

Oxygen electrode: (3/2)O₂+6e⁻+6H⁺→3H₂O

Entire DMFC: CH₃OH+(3/2)O₂→CO₂+2H₂O Chemical formula 1

The energy density of methanol as the fuel of the DMFC is theoretically 4.8 kW/L, which is 10 times or more the energy density of a general lithium ion secondary battery. That is, the fuel cell using methanol as the fuel has a high possibility to obtain a higher energy density than that of the lithium ion secondary battery. Accordingly, among the various fuel cells, the DMFC is most likely to be used as an energy source for mobile devices, electric automobiles and the like.

However, in the DMFC, there is an issue that the output voltage in the actual power generation is lowered to about 0.6 V or less, despite its theoretical voltage of 1.23 V. Such lowering of the output voltage is caused by voltage drop caused by internal resistance of the DMFC. In the DMFC, internal resistance such as resistance associated with reaction initiated in the both electrodes, reaction associated with transfer of substances, resistance generated when protons are transferred through the electrolyte membrane, and contact resistance exists. The energy that can be actually extracted as electric energy due to oxidation of methanol is expressed as a product of an output voltage in power generation and an electric charge flowing in a circuit. Thus, when the output voltage in power generation is lowered, the energy that can be actually extracted is decreased by just that much. The electric charge that can be extracted to the circuit due to oxidation of methanol is proportional to the methanol amount in the DMFC, where the entire amount of methanol is oxidized in the fuel cell electrode according to Chemical formula 1.

Further, the DMFC has an issue of methanol crossover. The methanol crossover is a phenomenon that methanol is transported from the fuel electrode side to the oxygen electrode side across the electrolyte membrane. Such a phenomenon is caused by the following two mechanisms. One mechanism is a phenomenon that methanol is diffused and migrated due to a methanol temperature difference between the fuel electrode side and the oxygen electrode side. The other mechanism is an electroosmotic phenomenon in which water is transferred associated with proton transfer and thus hydrated methanol is conveyed.

When the methanol crossover occurs, the transported methanol is oxidized in the catalyst layer of the oxygen electrode. The methanol oxidation reaction on the oxygen electrode side is the same as the foregoing oxidation reaction on the fuel electrode side, but may cause lowering of the output voltage of the DMFC. Further, methanol is not used for power generation on the fuel electrode side and consumed on the oxygen electrode side, and therefore the electric charge that can be extracted to the circuit is decreased by just that much. Further, since the catalyst layer of the oxygen electrode is not a platinum (Pt)-ruthenium (Ru) alloy catalyst but a platinum (Pt) catalyst, carbon monoxide (CO) is easily absorbed to the catalyst surface, and thus poisoning of the catalyst may be caused.

As described above, the DMFC has the two issues of the voltage lowering caused by the internal resistance and the methanol crossover, and the fuel consumption due to the methanol crossover. These issues cause lowering of power generation efficiency of the DMFC. Therefore, to improve the power generation efficiency of the DMFC, research and development to improve the characteristics of the material composing the DMFC and research and development to optimize the operation conditions of the DMFC have been actively made.

The researches to improve the characteristics of the material composing the DMFC include researches on the electrolyte membrane and researches on the catalyst on the fuel electrode side. For the electrolyte membrane, currently, a polyperfluoroalkyl sulfonic acid resin membrane (“Nafion (registered trademark),” Du Pont make) is generally used. As an electrolyte membrane having higher proton conductivity and higher methanol transportation block performance than those of the polyperfluoroalkyl sulfonic acid resin membrane, a fluorine polymer membrane, a carbon hydride-based polymer electrolyte membrane, a hydro gel-based electrolyte membrane and the like have been considered. For the catalyst on the fuel electrode side, research and development have been made on a catalyst having higher activity than that of the platinum (Pt)-ruthenium (Ru) alloy catalyst that is currently and generally used.

Improving the characteristics of the component material of the fuel cell as above is appropriate as a means to improve the power generation efficiency of the fuel cell. However, as is the case with the fact that the best suited catalyst to solve the foregoing two issues has not been found, under the present situation, no best suited electrolyte membrane has been found.

Meanwhile, Japanese Unexamined Patent Application Publication No. 59-191265 discloses the use of a liquid electrolyte (electrolytic solution) instead of the electrolyte membrane. In some cases, the electrolytic solution remains stationary between the oxygen electrode and the fuel electrode. In some cases, the electrolytic solution is flown in a flow path provided between the oxygen electrode and the fuel electrode, is channeled off outside, is returned again back into the flow path, and is circulated.

### SUMMARY

However, in the fuel cell using the electrolytic solution, the methanol crossover is caused by the foregoing diffusion and migration phenomenon of methanol, leading to lowering the output voltage. In addition, in such a fuel cell, there is an issue that bubbles of carbon dioxide are mixed in the electrolytic solution to lower the conductivity of the electrolytic solution. When the electrolytic solution is circulated, lowering of the output voltage is able to be delayed to some degree. However, it is difficult to avoid lowering of the output voltage itself. Meanwhile, it is conceivable to continuously exchange an old electrolytic solution for a new electrolytic solution instead of circulating the electrolytic solution. However, in this method, it is needless to say that a great amount of electrolytic solution is needed.

In view of the foregoing, in the application, it is desirable to provide a fuel cell system capable of suppressing influence of fuel crossover and achieving long-time power generation and an electronic device using it.

According to an embodiment, there is provided a fuel cell system including the following components A to C:

A: a power generation section having an electrolytic solution between a fuel electrode and an oxygen electrode;

B: a fuel supply section supplying a fuel to the fuel electrode; and

C: a control section making the fuel supply section stop supplying the fuel to the fuel electrode, and thereby performing electrolytic solution cleaning to remove a fuel contained in the electrolytic solution.

In the fuel cell system of an embodiment, when the fuel crosses over and is accumulated in the electrolytic solution and influence such as a lowered output voltage occurs, the control section makes the fuel supply section stop supplying the fuel. Thereby, the crossover amount of the fuel is inhibited from being increased, and the fuel accumulated in the electrolytic solution is oxidized and removed in the fuel electrode or the oxygen electrode. After that, when the control section makes the fuel supply section restart supplying the fuel to the fuel electrode, a high output voltage is restored. In the result, long-time power generation is enabled.

According to an embodiment, there is provided an electronic device including a fuel cell system. Such a fuel cell system is composed of the foregoing fuel cell system according to an embodiment.

The electronic device of an embodiment includes the fuel cell system capable of achieving long-time power generation according to an embodiment. Thus, the electronic device of an embodiment may address multifunction and high performance accompanied by increased electric power consumption.

The fuel cell system of an embodiment includes the control section making the fuel supply section stop supplying the fuel to the fuel electrode and thereby performing electrolytic solution cleaning to remove the fuel contained in the electrolytic solution. Thus, it is possible to suppress influence of fuel crossover and achieve long-time power generation without using a complicated separation mechanism. Accordingly, the fuel cell system according to an embodiment is suitable for an electronic device having multifunction and high performance necessitating high electric power consumption.

Additional features and advantages are described herein, and will be apparent from the following Detailed Description and the figures.

### BRIEF DESCRIPTION OF THE DRAWINGS

FIG. 1 is a diagram showing a schematic configuration of an electronic device including a fuel cell system according to a first embodiment;

FIG. 2 is a cross section showing a structure of the power generation section shown in FIG. 1;

FIG. 3 is a diagram for explaining an action of the fuel cell system shown in FIG. 1;

FIG. 4 is a flowchart showing an operation method of the fuel cell system shown in FIG. 1;

FIG. 5 is a diagram showing a schematic configuration of an electronic device including a fuel cell system according to a second embodiment;

FIG. 6 is a flowchart showing an operation method of the fuel cell system shown in FIG. 5;

FIG. 7 is a cross section showing a structure of a power generation section according to an embodiment;

FIG. 8 is a diagram showing a result of an example of an embodiment; and

FIG. 9 is a diagram showing a result of the example of an embodiment.

### DETAILED DESCRIPTION

Embodiments will be hereinafter described in detail.

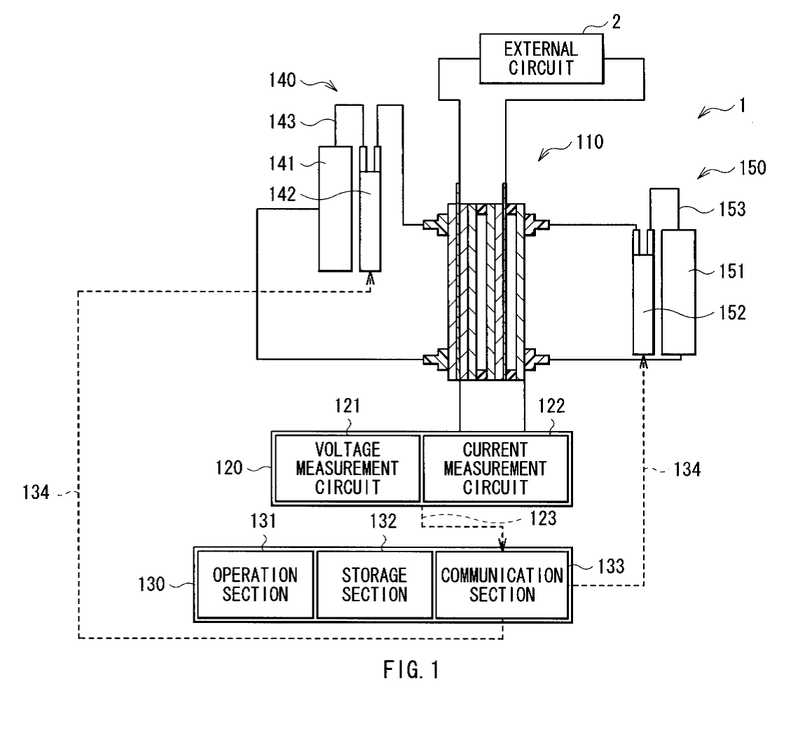

FIG. 1 shows a schematic configuration of an electronic device having a fuel cell system according to an embodiment. The electronic device is, for example, a mobile device such as a mobile phone and a Personal Digital Assistant (PDA) or a notebook Personal Computer (PC). The electronic device includes a fuel cell system 1 and an external circuit (load) 2 driven by electric energy generated in the fuel cell system 1.

The fuel cell system 1 includes, for example, a power generation section 110 composed of a fuel cell, a measurement section 120 for measuring an operation state of the power generation section 110, and a control section 130 for determining the operation condition of the power generation section 110 based on the measurement result by the measurement section 120. The fuel cell system 1 further includes an electrolytic solution supply section 140 for supplying, for example, sulfuric acid as an electrolytic solution F1 and a fuel supply section 150 for supplying, for example, methanol as a fuel F2 to the power generation section 110. When the electrolyte is supplied as a fluid, the electrolyte membrane is no longer needed. In the result, power generation is performed without being affected by temperature and humidity. In addition, the ion conductivity (proton conductivity) is improved more than that of a commonly used fuel cell using the electrolyte membrane. Further, there becomes no possibility that the proton conductivity is lowered due to deterioration of the electrolyte membrane and drying of the electrolyte membrane. Disadvantages such as flooding and moisture control in the oxygen electrode are also thereby resolved.

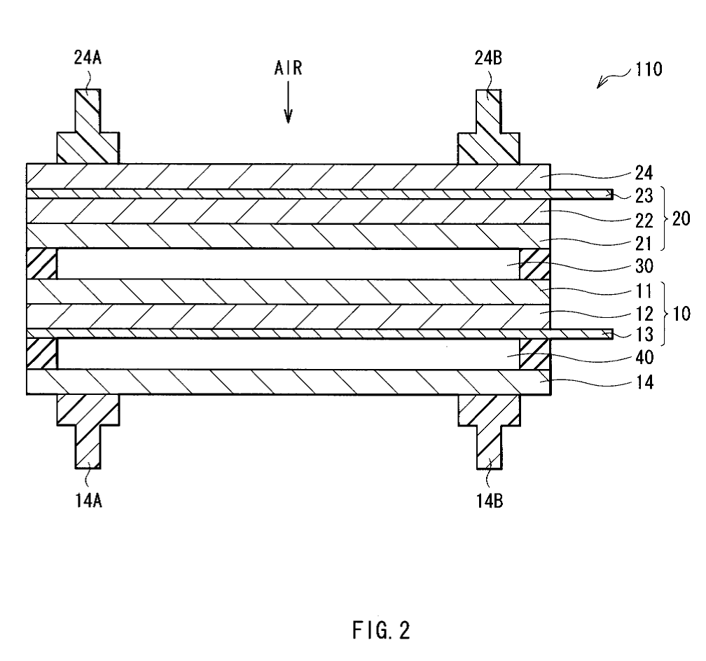

FIG. 2 shows a structure of the power generation section 110 shown in FIG. 1. The power generation section 110 is a so-called Direct Methanol Flow Based Fuel Cell (DMFFC). The power generation section 110 has a structure in which a fuel electrode (anode) 10 and an oxygen electrode (cathode) 20 are oppositely arranged. Between the fuel electrode 10 and the oxygen electrode 20, an electrolytic solution flow path 30 for flowing the electrolytic solution F1 is provided. Outside of the fuel electrode 10, that is, on the other side of the oxygen electrode 20, a fuel flow path 40 for flowing the fuel F2 is provided.

The fuel electrode 10 has a laminated structure in which a catalyst layer 11, a diffusion layer 12, and a current collector 13 are sequentially layered from the oxygen electrode 20 side. The laminated structure is contained in a package member 14. The fuel electrode 10 also has a function as a separation membrane to separate the electrolytic solution F1 from the fuel 2, and inhibits crossover to obtain a high energy density. The oxygen electrode 20 has a laminated structure in which a catalyst layer 21, a diffusion layer 22, and a current collector 23 are sequentially layered from the fuel electrode 10 side. The laminated structure is contained in a package member 24. Air or oxygen is supplied to the oxygen electrode 20 through the package member 24.

The catalyst layers 11 and 21 are made of a simple substance or an alloy of a metal such as palladium (Pd), platinum (Pt), iridium (Ir), rhodium (Rh), and ruthenium (Ru) as a catalyst. In addition to the catalyst, a proton conductor and a binder may be contained in the catalyst layers 11 and 21. As the proton conductor, the foregoing polyperfluoroalkyl sulfonic acid-based resin (“Nafion (registered trademark),” Du Pont make) or other resin having proton conductivity is cited. The binder is added in order to maintain the strength and the flexibility of the catalyst layers 11 and 21. As the binder, for example, a resin such as polytetrafluoroethylene (PTFE) and polyvinylidene fluoride (PVDF) is cited.

The diffusion layers 12 and 22 are made of, for example, a carbon cloth, a carbon paper, or a carbon sheet. The diffusion layers 12 and 22 are desirably water-repellent with the use of polytetrafluoroethylene (PTFE) or the like.

The current collectors 13 and 23 are made of, for example, a titanium (Ti) mesh.

The package members 14 and 24 are, for example, 2.0 mm thick, and are made of a material such as a titanium (Ti) plate that is able to be generally purchased. The material thereof is not particularly limited. The thickness of the package members 14 and 24 is desirably thin as much as possible.

In the electrolytic solution flow path 30 and the fuel flow path 40, for example, a fine flow path is formed by processing a resin sheet. The electrolytic solution flow path 30 and the fuel flow path 40 are adhered to the fuel electrode 10. The number of flow paths is not limited. The width, the height, and the length of the flow path are not particularly limited, but are desirably small.

The electrolytic solution flow path 30 is linked to the electrolytic solution supply section 140 (not shown in FIG. 2, and refer to FIG. 1) through an electrolytic solution inlet 24A and an electrolytic solution outlet 24B provided in the package member 24. The electrolytic solution F1 is supplied from the electrolytic solution supply section 140. The fuel flow path 40 is linked to the fuel supply section 150 (not shown in FIG. 2, and refer to FIG. 1) through a fuel inlet 14A and a fuel outlet 14B provided in the package member 14. The fuel F2 is supplied from the fuel supply section 150.

The measurement section 120 shown in FIG. 1 is intended to measure the operating voltage and the operating current of the power generation section 110. For example, the measurement section 120 has a voltage measurement circuit 121 for measuring the operating voltage of the power generation section 110, a current measurement circuit 122 for measuring the operating current, and a communication line 123 for sending the obtained measurement result to the control section 130.

The control section 130 shown in FIG. 1 controls an electrolytic solution supply parameter and a fuel supply parameter as operation conditions of the power generation section 110 based on the measurement result of the measurement section 120. For example, the control section 130 has an operation section 131, a storage (memory) section 132, a communication section 133, and a communication line 134. The electrolytic solution supply parameter includes, for example, the supply flow rate of the electrolytic solution F1. The fuel supply parameter includes, for example, the supply flow rate and the supply amount of the fuel F2, and may include the supply concentration according to needs. The control section 130 may be composed of a microcomputer, for example.

The operation section 131 calculates the output of the power generation section 110 based on the measurement result obtained by the measurement section 120, and sets the electrolytic solution supply parameter and the fuel supply parameter. Specifically, the operation section 131 calculates the average anode potential, the average cathode potential, the average output voltage, and the average output current by averaging the anode potentials, the cathode potentials, the output voltages, and the output currents that are sampled at a regular interval from the various measurement results inputted to the storage section 132, inputs the calculated results to the storage section 132, compares the various average values stored in the storage section 132 to each other, and thereby determines the electrolytic solution supply parameter and the fuel supply parameter.

The storage section 132 stores the various measurement values sent from the measurement section 120, the various average values calculated by the operation section 131 and the like.

The communication section 133 has a function to receive the measurement result from the measurement section 120 through the communication line 123 and input the received measurement result to the storage section 132, and a function to output respective signals for setting the electrolytic solution supply parameter and the fuel supply parameter to the electrolytic solution supply section 140 and the fuel supply section 150 through the communication line 134.

The electrolytic solution supply section 140 shown in FIG. 1 includes an electrolytic solution storage section 141, an electrolytic solution supply adjustment section 142, and an electrolytic solution supply line 143. The electrolytic solution F1 is circulated between the electrolytic solution supply section 140 and the power generation section 110. The electrolytic solution storage section 141 stores the electrolytic solution F1, and is composed of, for example, a tank or a cartridge. The electrolytic solution supply adjustment section 142 adjusts the supply flow rate of the electrolytic solution F1. The electrolytic solution supply adjustment section 142 is not particularly limited as long as the electrolytic solution supply adjustment section 142 is driven by a signal from the control section 130. The electrolytic solution supply adjustment section 142 is preferably composed of, for example, a valve driven by a motor or a piezoelectric device or an electromagnetic pump.

The fuel supply section 150 shown in FIG. 1 has a fuel storage section 151, a fuel supply adjustment section 152, and a fuel supply line 153. The fuel storage section 151 stores the fuel F2, and is composed of, for example, a tank or a cartridge. The fuel supply adjustment section 152 adjusts the supply flow rate and the supply amount of the fuel F2. The fuel supply adjustment section 152 is not particularly limited as long as the fuel supply adjustment section 152 is driven by a signal from the control section 130. The fuel supply adjustment section 152 is preferably composed of, for example, a valve driven by a motor or a piezoelectric device or an electromagnetic pump. The fuel supply section 150 may include a concentration adjustment section (not shown) for adjusting the supply concentration of the fuel F2. The concentration adjustment section may be omitted when pure (99.9%) methanol is used as the fuel F2, and the size of the system is thereby further reduced.

Further, the control section 130 makes the fuel supply section 150 stop supplying the fuel F1 to the fuel electrode 10, and thereby performs electrolytic solution cleaning to remove the fuel F1 contained in the electrolytic solution F2. Thereby, in the fuel cell system 1, influence of fuel crossover is inhibited and long-time power generation is achieved.

The fuel cell system 1 may be manufactured, for example, as follows.

First, for example, an alloy containing platinum (Pt) and ruthenium (Ru) at a given ratio as a catalyst and a dispersion solution of a polyperfluoroalkyl sulfonic acid-based resin (“Nafion (registered trademark),” Du Pont make) are mixed at a given ratio. Thereby, the catalyst layer 11 of the fuel electrode 10 is formed. The catalyst layer 11 is thermocompression-bonded to the diffusion layer 12 made of the foregoing material. Further, the current collector 13 made of the foregoing material is thermocompression-bonded by using a hot-melt adhesive or an adhesive resin sheet. The fuel electrode 10 is thereby formed.

Further, a catalyst in which platinum (Pt) is supported by carbon and a dispersion solution of polyperfluoroalkyl sulfonic acid-based resin (“Nafion (registered trademark),” Du Pont make) are mixed at a given ratio. Thereby, the catalyst layer 21 of the oxygen electrode 20 is formed. The catalyst layer 21 is thermocompression-bonded to the diffusion layer 22 made of the foregoing material. Further, the current collector 23 made of the foregoing material is thermocompression-bonded by using a hot-melt adhesive or an adhesive resin sheet. The oxygen electrode 20 is thereby formed.

Next, an adhesive resin sheet is prepared. A flow path is formed in the resin sheet, and thereby the electrolytic solution flow path 30 and the fuel flow path 40 are formed, which are thermocompression-bonded to the both sides of the fuel electrode 10.

Subsequently, the package members 14 and 24 made of the foregoing material are formed. In the package member 14, the fuel inlet 14A and the fuel outlet 14B that are made of, for example, a resin joint are provided. In the package member 24, the electrolytic solution inlet 24A and the electrolytic solution outlet 24B that are made of, for example, a resin joint are provided.

After that, the fuel electrode 10 and the oxygen electrode 20 are oppositely arranged with the electrolytic solution flow path 30 in between so that the fuel flow path 40 is located outside, and the resultant laminated body is contained in the package members 14 and 24. Thereby, the power generation section 110 shown in FIG. 2 is completed.

The power generation section 110 is incorporated in the system having the measurement section 120, the control section 130, the electrolytic solution supply section 140, and the fuel supply section 150 having the foregoing structure. The fuel inlet 14A and the fuel outlet 14B are connected to the fuel supply section 150 through the fuel supply line 153 made of, for example, a silicone tube. The electrolytic solution inlet 24A and the electrolytic solution outlet 24B are connected to the electrolytic solution supply section 140 through the electrolytic solution supply line 143 made of, for example, a silicone tube. Consequently, the fuel cell system 1 shown in FIG. 1 is completed.

In the fuel cell system 1, the fuel F2 is supplied to the fuel electrode 10, and reaction is initiated to generate a proton and an electron. The proton is transferred through the electrolytic solution F1 to the oxygen electrode 20, and then is reacted with an electron and oxygen to generate water. The reactions initiated in the fuel electrode 10, the oxygen electrode 20, and the entire power generation section 110 are expressed as Chemical formula 2. Thereby, part of the chemical energy of the fuel methanol is converted to electric energy, a current is extracted from the power generation section 110, and the external circuit 2 is driven. Carbon dioxide generated in the fuel electrode 10 and water generated in the oxygen electrode 20 are flown together with the electrolytic solution F1, and removed.

Fuel electrode 10: CH₃OH+H₂O→CO₂+6e⁻+6H⁺

Oxygen electrode 20: (3/2)O₂+6e⁻+6H⁺→3H₂O

Entire power generation section 110: CH₃OH+(3/2)O₂→CO₂+2H₂O Chemical formula 2

While the power generation section 110 is operated, the operating voltage and the operating current of the power generation section 110 are measured by the measurement section 120. Based on the measurement results, the control section 130 controls the electrolytic solution supply parameter and the fuel supply parameter described above as operation conditions of the power generation section 110. The measurement by the measurement section 120 and the parameter control by the control section 130 are frequently repeated. According to the characteristics change of the power generation section 110, the supply states of the electrolytic solution F1 and the fuel F2 are optimized.

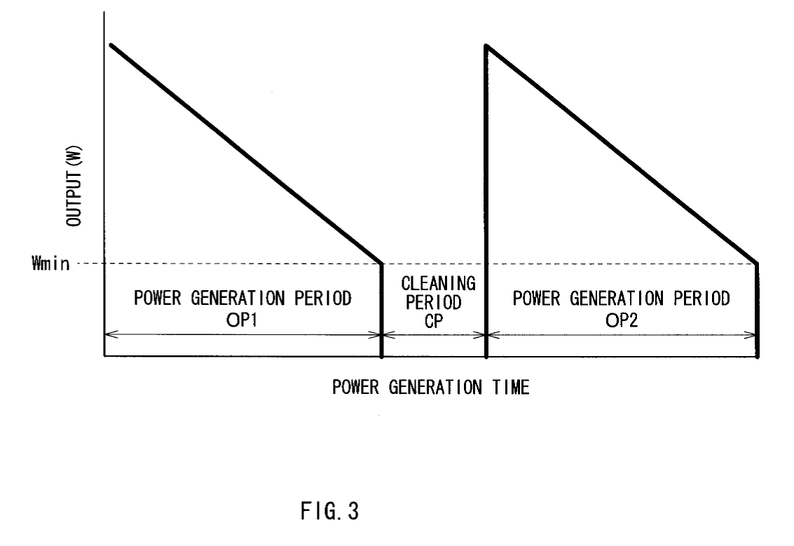

As shown in FIG. 3, as power generation period OP1 becomes longer, influence of lowered characteristics of the power generation section 110 is shown. For example, the fuel F2 crosses over and is accumulated in the electrolytic solution F1, the amount of the fuel F2 included in the electrolytic solution F1 is gradually increased, and the output voltage is lowered. In such a case, the control section 130 performs electrolytic solution cleaning.

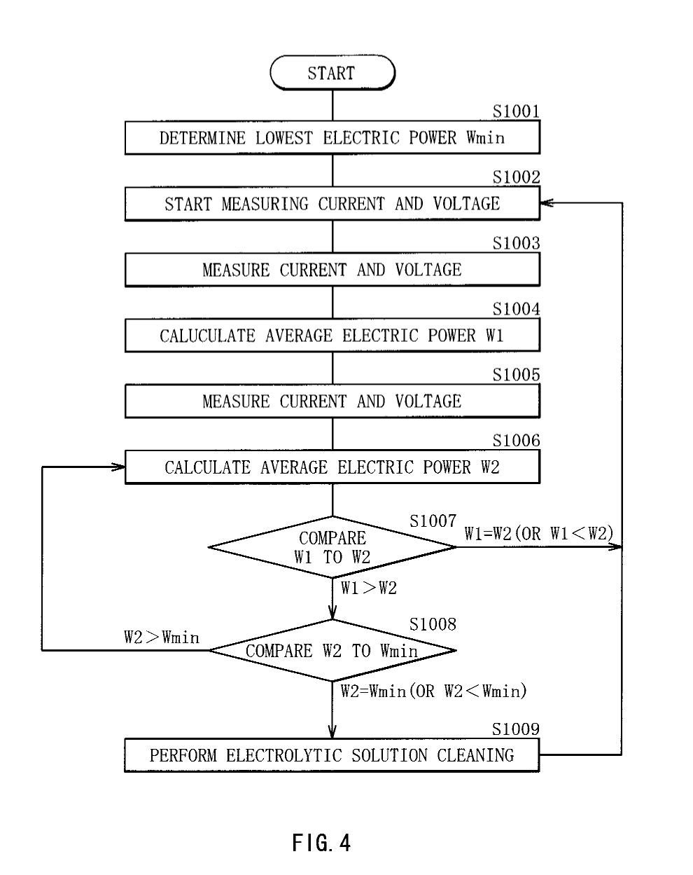

FIG. 4 shows an example of operating method of the power generation section 110 by the control section 130. In this operating method, change of generated electric power of the power generation section 110 is detected, and electrolytic solution cleaning is performed. Control algorithm depends on the operating method of the power generation section 110. Meanwhile, electrolytic solution cleaning method finally executed by the control algorithm is common to any operating method.

First, the lowest electric power Wmin of the fuel cell system 1 is determined (step S1001). The lowest electric power Wmin is a reference value. When an electric power is lower than the reference value, it is determined that electrolytic solution cleaning is needed. Since the minimum requisite electric power, the minimum requisite current, and the minimum requisite voltage vary according to each device, the value of the lowest electric power Wmin is previously set according to specifications of each device.

Immediately after starting operation of the power generation section 110, the control section 130 makes the voltage measurement circuit 121 and the current measurement circuit 122 of the measurement section 120 measure the generated current and the generated voltage of the power generation section 110 in operation (step S1002). Receiving a command from the control section 130, the measurement section 120 measures the generated current and the generated voltage of the power generation section 110 (step S1003), and stores the data thereof in the storage section 132 through the communication line 123. The sampling rate and the number of samples are not particularly limited. For example, the data may be collected by setting the sampling rate to 1/10 sec and setting the number of samples to 50 pcs as 1 set. If the sampling rate is excessively fast, the SN ratio deteriorates. Meanwhile, if the sampling rate is excessively slow, the response speed of the control system is lowered. Thus, for example, as described above, the sampling rate is preferably set to about 1/10 sec.

Next, the control section 130 makes the operation section 131 process the data stored in the storage section 132, calculate average electric power W1 (step S1004), and store the calculated average power W1 in the storage section 132.

Subsequently, again receiving a command from the control section 130, the measurement section 120 measures the generated current and the generated voltage of the power generation section 110, for example, by setting the sampling rate to 1/10 sec and setting the number of samples to 50 pcs (step S1105), and stores the data thereof in the storage section 132 through the communication line 123.

After that, the control section 130 makes the operation section 131 process the data stored in the storage section 132, calculate average electric power W2 (step S1006), and store the calculated average power W2 in the storage section 132.

After the average electric power W2 is calculated, the control section 130 inputs the average electric power W1 and the average electric power W2 stored in the storage section 132 to a comparison operation section in the operation section 131, where intercomparison processing is performed (step S1007).

In the case where the value of the average electric power W2 is equal to or larger than the value of the average electric power W1 (W1=W2 or W1<W2), determination is made that the performance of the power generation section 110 is not lowered. The value of the average electric power W1 and the value of the average electric power W2 are deleted, the procedure is returned back to step S1002, and measurement of the generated current and the generated voltage are newly started.

Meanwhile, in the case where the value of the average electric power W2 is smaller than the value of the average electric power W1 (W1>W2), the control section 130 determines that the performance of the power generation section 110 is lowered, and compares the average electric power W2 with the lowest electric power Wmin (step S1008).

In the case where the value of the average electric power W2 is equal to or larger than the value of the lowest electric power Wmin (W2=Wmin or W2>Wmin), the procedure is returned back to step S1005, measurement of the generated current and the generated voltage are performed again, and the average electric power W2 is calculated.

Meanwhile, in the case where the value of the average electric power W2 is smaller than the lowest electric power Wmin (W2<Wmin), the control section 130 makes the fuel supply section 150 stop supplying the fuel F2 to the fuel electrode 10. Thereby, the electrolytic solution cleaning is performed (step S1009: cleaning period CP in FIG. 3). When supplying the fuel F2 is stopped, increase of the crossover amount of the fuel F2 is blocked. In addition, the fuel F2 accumulated in the electrolytic solution F1 is oxidized and removed in the fuel electrode 10 or the oxygen electrode 20. Since the length of the electrolytic solution cleaning period CP depends on the amount of the fuel F2 included in the electrolytic solution F1, the length of the electrolytic solution cleaning period CP is not particularly limited.

It is possible that the control section 130 makes or does not make the power generation section 110 stop power generation during the electrolytic solution cleaning period CP. When the amount of the fuel F1 contained in the electrolytic solution F2 is very small, electrolytic solution cleaning is finished in a short period of time. In this case, electrolytic solution cleaning is enabled only by making the fuel supply section 150 stop supplying the fuel F1 to the fuel electrode 10 without making the power generation section 110 stop power generation. However, when the amount of the fuel F1 contained in the electrolytic solution F2 is large, it is necessary to make the power generation section 110 stop power generation once, make the fuel supply section 150 stop supplying the fuel F1 to the fuel electrode 10, and then executes electrolytic solution cleaning. FIG. 3 shows a case that power generation by the power generation section 110 is stopped in the cleaning period CP.

After that, the control section 130 makes the fuel supply section 150 supply again the fuel F2 to the fuel electrode 10, and a high output voltage is restored (power generation period OP2 in FIG. 3). Accordingly, long-time power generation is enabled.

As described above, in this embodiment, the control section 130 makes the fuel supply section 150 stop supplying the fuel F2 to the fuel electrode 10, and thereby the electrolytic solution cleaning to remove the fuel F2 contained in the electrolytic solution F1 is performed. Thus, it is possible to suppress influence of fuel crossover and achieve long-time power generation without using a complicated separation mechanism. Accordingly, this embodiment is suitable for an electronic device having multifunction and high performance necessitating a high electric power consumption.

In an embodiment, a description has been given of the case that the control section 130 detects change of generated electric power of the power generation section 110, and performs electrolytic solution cleaning. However, the control section 130 may determine the timing of performing electrolytic solution cleaning based on at least one of the generated current, the generated voltage, and the generated electric power of the power generation section 110.

### Second Embodiment

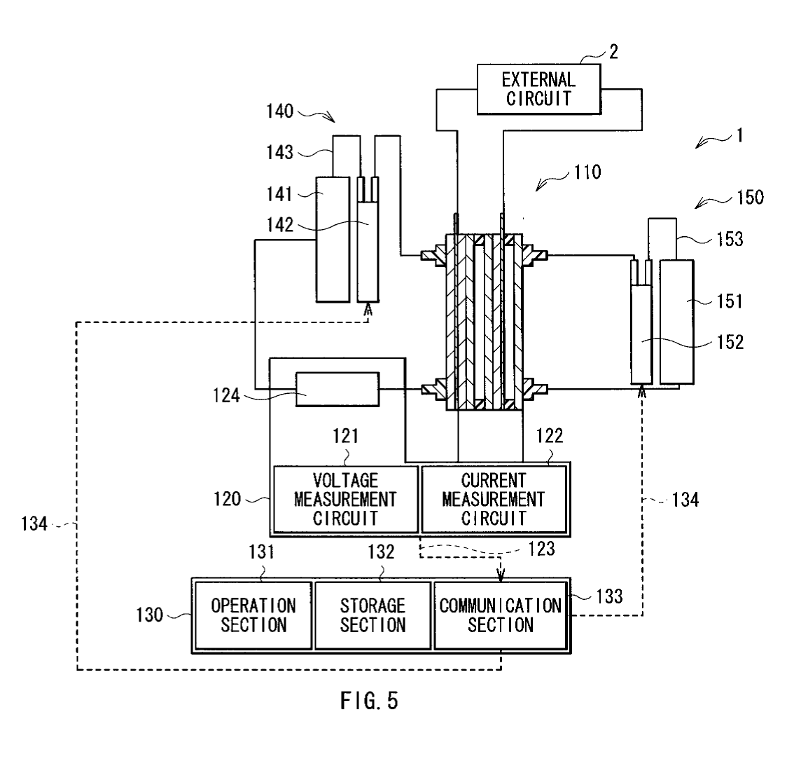

FIG. 5 shows a schematic configuration of an electronic device having a fuel cell system according to a second embodiment. The fuel cell system has the same configuration as that of the fuel cell system 1 of the first embodiment, except that the measurement section 120 includes a concentration measurement mechanism 124 for measuring the concentration of the electrolytic solution F1. Therefore, a description will be given by using the same referential symbols for the corresponding elements.

Structures of the power generation section 110, the control section 130, the electrolytic solution supply section 140, and the fuel supply section 150 are similar to those of the first embodiment.

The concentration measurement mechanism 124 is composed of, for example, a methanol sensor, and is provided in the vicinity of the electrolytic solution outlet 24B of the electrolytic solution supply line 143. Except for that, the structure of the measurement section 120 is similar to that of the first embodiment.

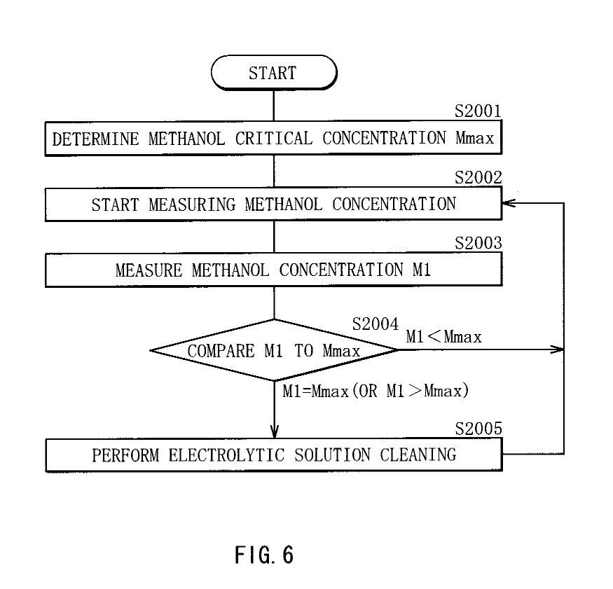

FIG. 6 shows an example of operating method of the power generation section 110 by the control section 130. In this operating method, the amount of the fuel F2 contained in the electrolytic solution F1 is detected based on the measurement result of the concentration measurement mechanism 124, and electrolytic solution cleaning is performed based on the detected value.

First, the critical concentration Mmax of the fuel F2 contained in the electrolytic solution F1 (hereinafter referred to as “methanol critical concentration”) is determined (step S2001). The methanol critical concentration Mmax is a reference value. In the case where a methanol concentration is higher than the reference value, it is determined that electrolytic solution cleaning is needed. Since the minimum requisite electric power, the minimum requisite current, and the minimum requisite voltage vary according to each device, the value of the methanol critical concentration Mmax is previously set according to specifications of each device. Specifically, the methanol critical concentration Mmax is set to, for example, about 2M.

Immediately after starting operation of the power generation section 110, the control section 130 makes the concentration measurement mechanism 124 of the measurement section 120 start measuring the concentration of the fuel F2 contained in the electrolytic solution F1 (hereinafter referred to as “methanol concentration”) (step S2002). Receiving a command from the control section 130, the measurement section 120 measures methanol concentration M1 of the electrolytic solution F1 (step S2003), and stores the data thereof in the storage section 132 through the communication line 123.

Next, the control section 130 compares the methanol concentration M1 stored in the storage section 132 to the methanol critical concentration Mmax (step S2004).

If the value of the methanol concentration M1 is smaller than the methanol critical concentration Mmax (M1<Mmax), the value of the methanol concentration M1 is deleted, the procedure is returned back to step S2002, and measurement of the methanol concentration M1 is performed again.

Meanwhile, if the value of the methanol concentration M1 is equal to or larger than the methanol critical concentration Mmax (M1=Mmax or M1>Mmax), the control section 130 makes the fuel supply section 150 stop supplying the fuel F2 to the fuel electrode 10, and thereby the electrolytic solution cleaning is performed (step S2005: cleaning period CP in FIG. 3). Electrolytic solution cleaning may be executed in the same manner as that of the first embodiment.

After that, the control section 130 makes the fuel supply section 150 supply again the fuel F2 to the fuel electrode 10, and a high output voltage is restored (power generation period OP2 in FIG. 3). Accordingly, long-time power generation is enabled.

As described above, in an embodiment, in the same manner as that of the first embodiment, the control section 130 makes the fuel supply section 150 stop supplying the fuel F2 to the fuel electrode 10, and thereby the electrolytic solution cleaning to remove the fuel F2 contained in the electrolytic solution F1 is performed. Thus, it is possible to suppress influence of fuel crossover and achieve long-time power generation without using a complicated separation mechanism. Accordingly, this embodiment is suitable for an electronic device having multifunction and high performance necessitating high electric power consumption.

Modification

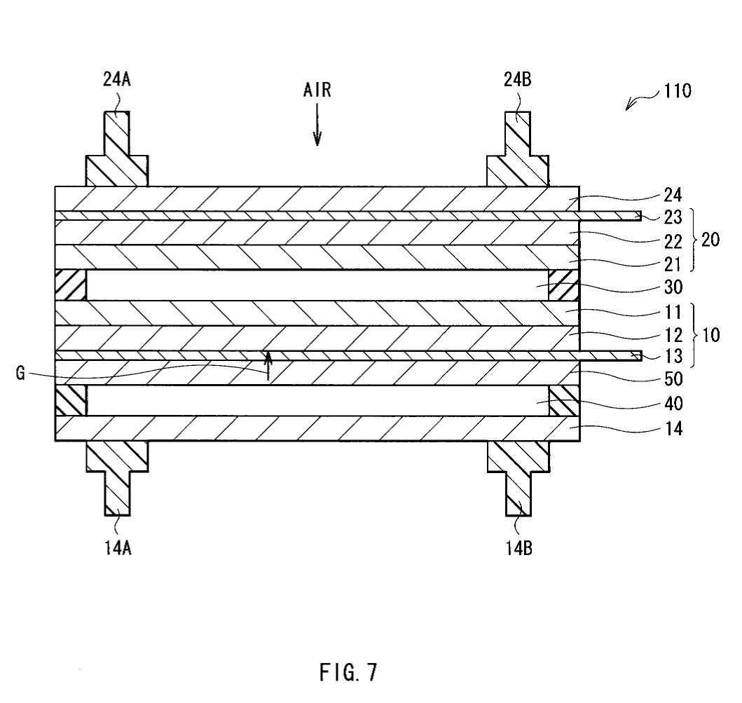

FIG. 7 shows a modification of the power generation section 110 described in the first embodiment and the second embodiment. The power generation section 110 has the same structure as that of the first embodiment and the second embodiment, except that a gas-liquid separation membrane 50 is provided between the fuel flow path 40 and the fuel electrode 10. Therefore, a description will be given by using the same referential symbols for the corresponding elements.

The gas-liquid separation membrane 50 may be composed of a membrane across which liquid alcohol such as polytetrafluoroethylene (PTFE), polyvinylidene fluoride (PVDF), and polypropylene (PP) is not transported.

In this modification, the gas-liquid separation membrane 50 is provided between the fuel flow path 40 and the fuel electrode 10. Therefore, when fuel pure methanol in a state of liquid is flown in the fuel flow path 40, the pure methanol is naturally volatilized, passes through the gas-liquid separation membrane 50 in a state of gas G through the face where the fuel flow path 40 is contacted with the gas-liquid separation membrane 50, and is supplied to the fuel electrode 10. Thus, the fuel is efficiently supplied to the fuel electrode 10, and reaction is stably made. Further, since the fuel in the gas state is supplied to the fuel electrode 10, electrode reactivity is improved, crossover is hardly generated, and high performance is obtained even in the electronic device having a highly-loaded external circuit 2. Further, pure (99.9%) methanol is able to be used as the fuel fluid F2, and the high energy density characteristics as the characteristics of the fuel cell are further utilized. In addition, the concentration adjustment section for adjusting the supply concentration of the fuel F2 may be omitted in the fuel supply section 150, and the size of the system is thereby further reduced.

### EXAMPLE

Further, a description will be given of a specific example of the application. In the following example, the power generation section 110 having the gas-liquid separation membrane 50 as shown in FIG. 7 was formed, and the characteristics thereof were evaluated. Thus, in the following example, a description will be given with reference to FIG. 1 and FIG. 7, and by using the same referential symbols.

The power generation section 110 having a structure similar to that of FIG. 7 was formed. First, an alloy containing platinum (Pt) and ruthenium (Ru) at a given ratio as a catalyst and a dispersion solution of a polyperfluoroalkyl sulfonic acid-based resin (“Nafion (registered trademark),” Du Pont make) were mixed at a given ratio. Thereby, the catalyst layer 11 of the fuel electrode 10 was formed. The catalyst layer 11 was thermocompression-bonded to the diffusion layer 12 made of the foregoing material (HT-2500, E-TEK Co. make) for 10 minutes under the conditions of 150 deg C. and 249 kPa. Further, the current collector 13 made of the foregoing material was thermocompression-bonded by using a hot-melt adhesive or an adhesive resin sheet. The fuel electrode 10 was thereby formed.

Further, a catalyst in which platinum (Pt) was supported by carbon as a catalyst and a dispersion solution of polyperfluoroalkyl sulfonic acid-based resin (“Nafion (registered trademark),” Du Pont make) were mixed at a given ratio. Thereby, the catalyst layer 21 of the oxygen electrode 20 was formed. The catalyst layer 21 was thermocompression-bonded to the diffusion layer 22 made of the foregoing material (HT-2500, E-TEK Co. make) in the same manner as that of the catalyst layer 11 of the fuel electrode 10. Further, the current collector 23 made of the foregoing material was thermocompression-bonded in the same manner as that of the current collector 13 of the fuel electrode 10. The oxygen electrode 20 was thereby formed.

Next, an adhesive resin sheet was prepared. A flow path was formed in the resin sheet, and thereby the electrolytic solution flow path 30 and the fuel flow path 40 were formed, which were thermocompression-bonded to the both sides of the fuel electrode 10.

Subsequently, the package members 14 and 24 made of the foregoing material were formed. In the package member 14, the fuel inlet 14A and the fuel outlet 14B that were made of, for example, a resin joint were provided. In the package member 24, the electrolytic solution inlet 24A and the electrolytic solution outlet 24B that were made of, for example, a resin joint were provided.

After that, the fuel electrode 10 and the oxygen electrode 20 were oppositely arranged with the electrolytic solution flow path 30 in between so that the fuel flow path 40 was located outside, and the resultant laminated body was contained in the package members 14 and 24. At that time, the gas-liquid separation membrane 50 (Millipore Co. make) was provided between the fuel flow path 40 and the fuel electrode 10. Thereby, the power generation section 110 shown in FIG. 7 was completed.

The power generation section 110 was incorporated in the system having the measurement section 120, the control section 130, the electrolytic solution supply section 140, and the fuel supply section 150 having the foregoing structure. Thereby, the fuel cell system 1 shown in FIG. 1 was configured. At that time, the electrolytic solution supply adjustment section 142 and the fuel supply adjustment section 152 were composed of a diaphragm constant rate pump (KNF Co., Ltd. make). Each pump was directly connected to the fuel inlet 14A and the electrolytic solution inlet 24A through the electrolytic solution supply line 143 and the fuel supply line 153 made of a silicone tube. The electrolytic solution F1 and the fuel F2 were respectively supplied to the electrolytic solution flow path 30 and the fuel flow path 40 at a given flow rate. As the electrolytic solution F1, 0.5 M sulfuric acid was used, and the flow rate was 1.0 ml/min. As the fuel F2, pure (99.9%) methanol was used, and the flow rate was 0.080 ml/min.

Evaluation

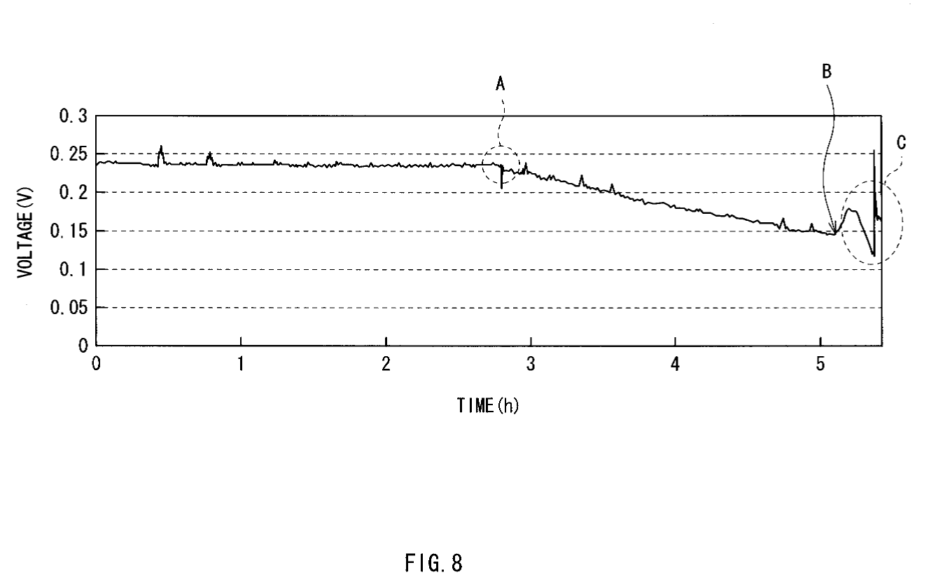

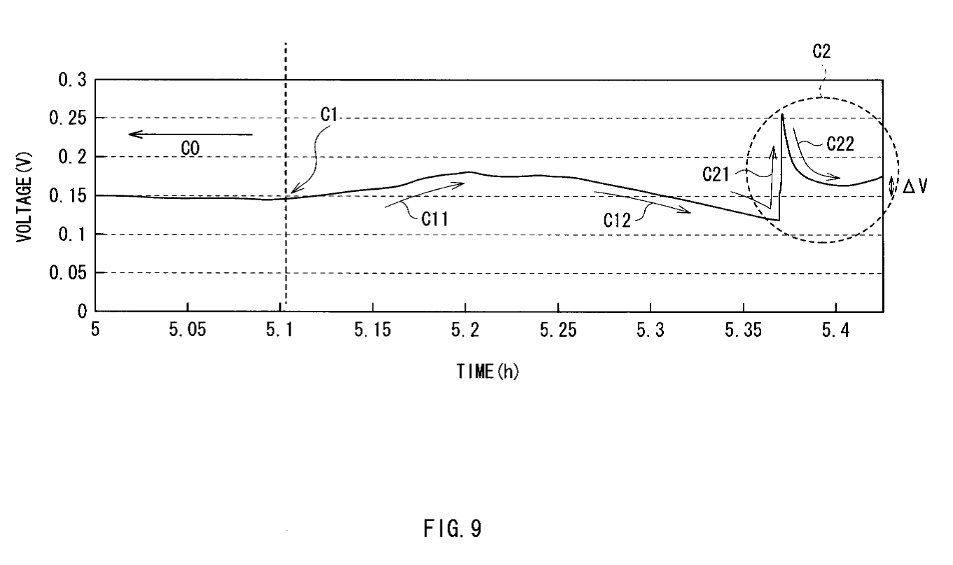

The obtained fuel cell system 1 was connected to an electrochemical measurement device (Multistat 1480, Solartron Co. make), long-time power generation was performed at a current density of 200 mA/cm², and influence of methanol crossover due to circulating the electrolytic solution F1 and influence of the electrolytic solution cleaning were examined. The results are shown in FIG. 8 and FIG. 9.

FIG. 8 shows the influence of methanol crossover due to circulating the electrolytic solution F1. Until point A, the electrolytic solution F1 was not circulated, the electrolytic solution F1 flowing from the electrolytic solution inlet 24A into the electrolytic solution flow path 30 was ejected from the electrolytic solution outlet 24B to be pooled in a waste tank (not shown), and new electrolytic solution F1 was typically flown in the electrolytic solution flow path 30. After the point A, the electrolytic solution F1 was circulated between the power generation section 110 and the electrolytic solution supply section 140. At point B, the supply of the fuel F2 was stopped and electrolytic solution cleaning was started. At that time, power generation by the power generation section 110 was not stopped, and electrolytic solution cleaning was performed while power generation was continued. At point C, the supply of the fuel F2 was restarted.

As shown in FIG. 8, after point A, the electrolytic solution F1 was circulated. Thus, due to influence of methanol accumulated in the electrolytic solution F1, the characteristics were significantly lowered.

FIG. 9 is an exploded diagram of a section in the vicinity of point C (section surrounded by the dotted line) of FIG. 8. C0 shows the state in the period before electrolytic solution cleaning. C1 shows the state in the period immediately after stopping supply of the fuel F2, and shows that only the electrolytic solution F1 was circulated. C2 shows a state in the period immediately after restarting supply of the fuel F2.

As evidenced by FIG. 9, when the supply of the fuel F2 was stopped at C1, the characteristics were improved (arrow C11 of FIG. 9), and then was lowered (arrow C12 of FIG. 9). The reason for such temporal improvement of the characteristics came from the following fact. That is, methanol crossover was inhibited from being increased, and electrolytic solution cleaning was performed. The reason that the characteristics were lowered after being temporally improved came from the following fact. That is, since the supply of the fuel F2 was stopped, methanol as the fuel F2 was lacked, and the power generation section 110 was not able to perform power generation at a current density of 200 mA/cm².

When the supply of the fuel F2 was restarted at C2, the characteristics were drastically improved (arrow C21 of FIG. 9), and settled in a certain value (arrow C22 of FIG. 9). The reason for such drastic improved characteristics came from the following fact. That is, the accumulated fuel F2 was excessively supplied. The settled value was better than the characteristics in C0 before electrolytic solution cleaning (ΔV in FIG. 9), and showed effect of electrolytic solution cleaning.

That is, it was found that when the control section 130 made the fuel supply section 150 stop supplying the fuel F2 to the fuel electrode 10 and thereby electrolytic solution cleaning to remove the fuel F2 contained in the electrolytic solution F1 was performed, influence of fuel crossover was suppressed, the high characteristics were remained, and long-time power generation was enabled.

The application has been described with reference to the embodiments and the example. However, the application is not limited to the foregoing embodiments and the foregoing example, and various modifications may be made. For example, in the foregoing embodiments and the foregoing example, the description has been given of the case that the electrolytic solution F1 is circulated between the power generation section 110 and the electrolytic solution supply section 140. However, it is possible that the electrolytic solution F1 is not circulated and maintained stationary between the fuel electrode 10 and the oxygen electrode 20.

Further, for example, in the foregoing embodiments and the foregoing example, the description has been specifically given of the structures of the fuel electrode 10, the oxygen electrode 20, the fuel flow path 30, and the electrolytic solution flow path 40. However, the structures of the fuel electrode 10, the oxygen electrode 20, the fuel flow path 30, and the electrolytic solution flow path 40 may have other structure, or may be made of other material. For example, the fuel flow path 30 may be also composed of a porous sheet or the like, in addition to the flow path obtained by processing the resin sheet as described in the foregoing embodiments and the foregoing example.

Further, for example, in the foregoing embodiments and the foregoing example, the description has been given of the power generation section 110 having the single fuel cell. However, the application is also applicable to a case that power generation section 110 is structured by layering a plurality of fuel cells in the vertical direction (lamination direction) or the horizontal direction (lamination in-plane direction).

In addition, for example, the material and the thickness of each element, power generation conditions of the power generation section 110 and the like are not limited to those described in the foregoing embodiments and the foregoing example. Other material, other thickness, or other operation conditions may be adopted.

Furthermore, in the foregoing embodiments, the description has been given of the case that the fuel F2 is supplied from the fuel supply section 150 to the fuel electrode 10. However, it is possible that the fuel electrode 10 is an encapsulated type electrode and a fuel F2 is supplied according to needs.

In addition, for example, the fuel F2 may be other liquid fuel such as ethanol and dimethyl ether in addition to methanol. The electrolytic solution F1 is not particularly limited as long as an electrolytic solution has proton (H⁺) conductivity. For example, in addition to sulfuric acid, phosphoric acid or an ionic liquid is cited.

Furthermore, the present application is also applicable to a fuel cell using a material such as hydrogen other than the liquid fuel as a fuel, in addition to the fuel cell using the liquid fuel.

Furthermore, in the foregoing embodiments and the foregoing example, air supply to the oxygen electrode 20 is made by natural ventilation. However, air may be forcibly supplied by utilizing a pump or the like. In this case, instead of air, oxygen or a gas containing oxygen may be supplied.

Furthermore, in the foregoing embodiments and the foregoing example, the description has been given of the case that the fuel electrode 10 and the oxygen electrode 20 are oppositely arranged with the electrolytic solution flow path 30 in between with the fuel flow path 40 outside in the power generation section 110. However, the application is also applicable to the fuel cell system having a power generation section with other structure.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A fuel cell system comprising:
a power generation section having an electrolytic solution between a fuel electrode and an oxygen electrode;
a fuel supply section supplying a fuel to the fuel electrode; and
a control section making the fuel supply section stop supplying the fuel to the fuel electrode and thereby performing electrolytic solution cleaning to remove a fuel contained in the electrolytic solution.

2. The fuel cell system according to claim 1, wherein the control section determines timing of performing the electrolytic solution cleaning based on at least one of a generated current, a generated voltage, and a generated electric power of the power generation section.

3. The fuel cell system according to claim 1 comprising:
a concentration measurement mechanism measuring a concentration of the electrolytic solution,
wherein the control section detects an amount of the fuel contained in the electrolytic solution based on a measurement result of the concentration measurement mechanism, and determines timing of performing the electrolytic solution cleaning based on a detected value.

4. The fuel cell system according to claim 1, wherein the control section makes the power generation section stop power generation during a period of the electrolytic solution cleaning.

5. The fuel cell system according to claim 1 comprising:
an electrolytic solution supply section circulating the electrolytic solution between the electrolytic solution supply section and the power generation section.

6. An electronic device comprising:
a fuel cell system,
wherein the fuel cell system includes
a power generation section having an electrolytic solution between a fuel electrode and an oxygen electrode,
a fuel supply section supplying a fuel to the fuel electrode, and
a control section making the fuel supply section stop supplying the fuel to the fuel electrode and thereby performing electrolytic solution cleaning to remove a fuel contained in the electrolytic solution.
